(19) United States
(12) Patent Application Publication
(10) Pub. No.: US 2024/0288112 A1
(43) Pub. Date: Aug. 29, 2024

(54) SUPPORT ASSEMBLY

(71) Applicant: Aktiebolaget SKF, Göteborg (SE)

(72) Inventors: Fausto BARACCA, Massa (IT); Andrea A. BERTOLINI, Carrara (IT); Alessio NEBBIA COLOMBA, Pisa (IT)

(21) Appl. No.: 18/443,527

(22) Filed: Feb. 16, 2024

(30) Foreign Application Priority Data
Feb. 23, 2023 (IT) 102023000003174

(51) Int. Cl. F16M 11/14

(52) U.S. Cl. CPC F16M 11/14; F16M 2200/022

(57) ABSTRACT

A support assembly (10) for a rotatable element. The support assembly (10) has a frame (20) provided with a mounting seat (20a) and a bearing unit (30) arranged inside the mounting seat. The bearing unit (30) is provided with a stationary radially outer ring (31) delimited radially on the outside by a respective spherical surface (31′). The frame (20) is provided with a liner (40) of elastomeric material, co-molded on the seat (20a). The liner (40) is radially interposed between the seat (20a) of the frame (20) and the spherical surface (31′) of the radially outer ring (31).

### CROSS-REFERENCE TO RELATED APPLICATION

This application claims priority to Italian Application No. 102023000003174, filed Feb. 23, 2023, the entirety of which is hereby incorporated by reference.

### FIELD

The present disclosure relates to a support assembly for a bearing unit with rolling bodies.

### BACKGROUND

Known bearing units are usually provided with a radially outer ring that is fastened to a stationary element, for example a frame, of a radially inner ring supporting a rotatable element, for example a rotary shaft, and a plurality of rolling elements interposed between the two rings to enable the relative rotation thereof.

The bearing units are seated in a radially inner seat of a frame. The related support assembly of the rotatable element therefore comprises the frame and the bearing unit.

The known bearing units described above are used in diverse industrial applications, and the text below, while being generally applicable, makes explicit reference to the use of such bearing units in heating, ventilation and air-conditioning systems, i.e. climate control systems for rooms, and where the bearing units are installed in the fans of said systems to enable rotation of the relative rotary support shafts for the fan blades.

These room climate control systems are in turn widely used in the civil engineering sector (for example air-conditioning for skyscrapers or large airports) and in the aeronautical, automobile and railway sectors, and one of the major challenges in all of these fields is reducing vibration and noise levels, in particular at high frequencies. Furthermore, given that these applications involve continuous operation (24 hours a day, seven days a week), frictional resistance values and the related heat generated also need to be taken into consideration and minimized.

Specifically, excessive levels of vibration result in greater energy consumption and may cause premature failure, with resulting unscheduled downtime required to carry out maintenance work, with a consequent drop in production volumes. Similarly, high levels of noise make working environments unhealthy for workers.

Consequently, in order to reduce the vibrations generated by the rotary shafts and induced in the frames through the bearing units, and to minimize the related noise levels, and to minimize any damage caused by such vibrations to the bearing unit itself, said bearing units also comprise a ring made of elastomeric material that is interposed between the outer ring of the bearing unit and a mounting seat of the bearing unit itself in the frame, and that is usually fitted onto an outer surface of the outer ring.

Although the bearing units described above reduce levels of vibration and noise to some extent, they nonetheless have many problems and drawbacks relating to assembly and reliability, since the elastomer ring lining the metal outer ring of the bearing unit often tends to be torn or damaged during assembly of the bearing unit in the respective seat, and also tends to become misaligned in relation to the outer ring when in use. Indeed, to obviate the need to increase the size of the mounting seat of the bearing unit, the radial thickness of the elastomer ring is kept as small as possible, which however adversely affects its mechanical strength and stability, especially when the rotation speeds of the rotary shaft of the application are very high, i.e. speeds typical of the systems mentioned above. Conversely, using a larger mounting seat significantly increases the size of the frame and of the support assembly as a whole.

### SUMMARY

The present disclosure is intended to provide a support assembly comprising a frame and a bearing unit with rolling bodies that not only simply and cheaply overcomes the drawbacks described above, but also further contributes to improving the capacity to reduce vibration and noise levels. This objective is achieved by a novel frame that is made of pressed steel and provided with a liner made of elastomeric material in order to reduce vibration levels.

Accordingly, the present disclosure provides a support assembly for a bearing unit with rolling bodies having the features set out in the attached claims.

### BRIEF DESCRIPTION OF THE DRAWINGS

The present disclosure is described below with reference to the attached drawings, which show some non-limiting example embodiments of the present disclosure, in which:

FIG. 1 is a cross-sectional view of a support assembly according to a preferred embodiment of the present disclosure, and

FIG. 2 is a magnified cross-sectional view of a detail of the support assembly in FIG. 1.

### DETAILED DESCRIPTION

A preferred embodiment of a support assembly according to the present disclosure is described below purely by way of example.

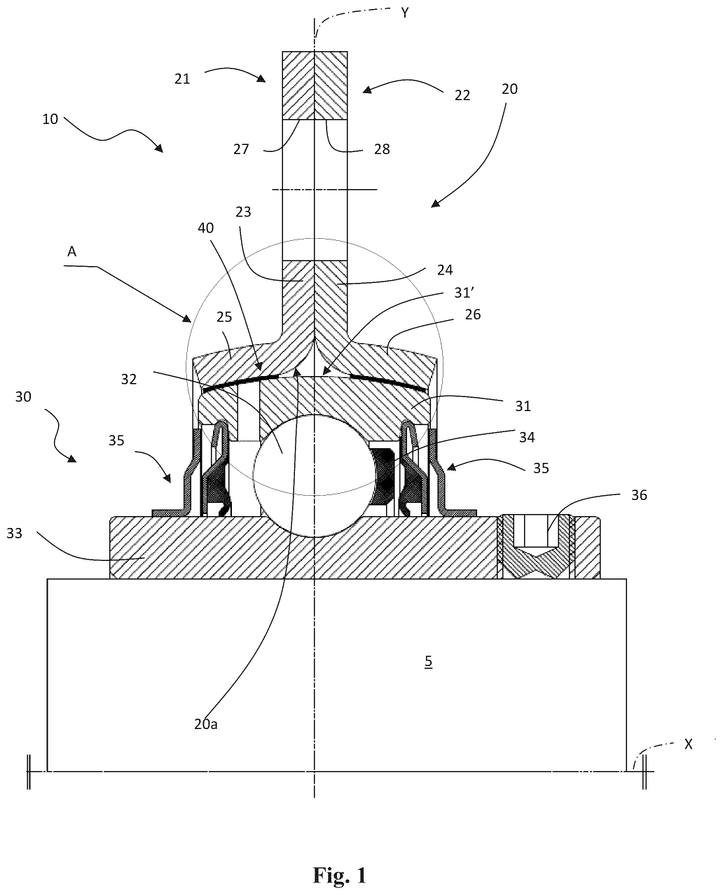

In FIG. 1, a preferred embodiment of a support assembly according to the present disclosure is indicated as a whole with reference sign 10. The support assembly 10 comprises a frame 20 (shown only partially in FIG. 1) and a bearing unit 30, where the support assembly 10 is advantageously but not exclusively used in the field of ventilation systems.

The bearing unit 30 is designed to be contained in a radially inner mounting seat 20a of the frame 20 and comprises:
a stationary radially outer ring 31 that is radially delimited on the outside by a respective spherical surface 31′,
a radially inner ring 33 that is rotary about a central axis of rotation X of the bearing unit 30 and rigidly connected by means of a locking element 36 (for example one or more socket-head screws) to a rotatable element 5, for example a rotary support shaft for the blades of a fan,
a row of rolling bodies 32, in this case balls, interposed between the radially outer ring 31 and the radially inner ring 33,
a cage 34 for holding the rolling elements, for keeping the rolling elements of the row of rolling elements 32 in position,
a pair of sealing devices 35 arranged on opposite sides in relation to the row of rolling bodies 32 to seal the bearing unit against the external environment.

Throughout the present description and in the claims, terms and expressions indicating positions and orientations, such as “radial” and “axial”, are to be understood with reference to the central axis of rotation X of the bearing unit 30.

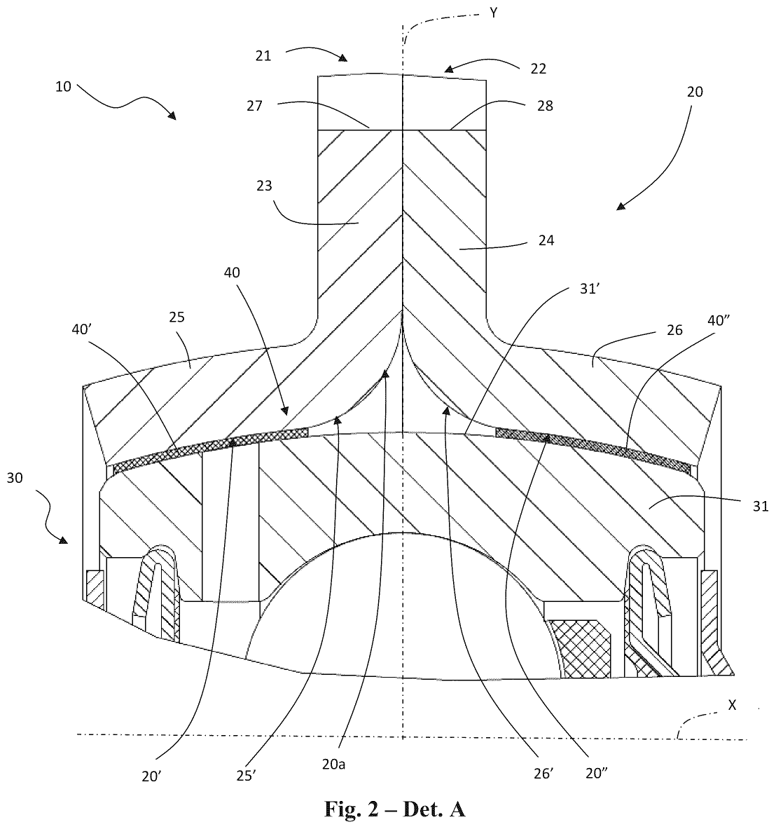

Also with reference to FIG. 2, the frame 20 is advantageously made of pressed steel and comprises a first half-frame 21 and a second half-frame 22, the two half-frames being symmetrical about an axis Y transverse to the bearing unit 30 and to the support assembly 10.

The first half-frame 21 comprises a flange portion 23 transverse to the axis X, and an annular portion 25 that is radially inside, connected to and contiguous with the flange portion 23, and that is radially delimited on the inside by a spherical surface 25′, or rather by an arc having a spherical surface shaped to fit the spherical surface 31′ of the radially outer ring 31.

Similarly, the second half-frame 22 comprises a flange portion 24 transverse to the axis X, and an annular portion 26 that is radially inside, connected to and contiguous with the flange portion 24, and that is radially delimited on the inside by a spherical surface 26′, or more precisely by an arc having a spherical surface shaped to fit the spherical surface 31′ of the radially outer ring 31.

The two flange portions 23, 24 are axially brought together with the relative annular portions extending in axially opposing directions, and have corresponding holes 27, 28 traversed by locking elements (of a known type and therefore not shown in the figures) to rigidly connect the two half-frames together.

The spherical surfaces 25′ and 26′ of the two annular portions 25, 26 form the mounting seat 20a of the bearing unit 30 inside the frame 20.

In summary, the preferred solution of the frame 20 comprising the two half-frames 21, 22 facilitates the mounting of the support assembly: the two half-frames 21, 22 are brought axially together to envelop the bearing unit 30, and are subsequently connected rigidly together using the aforementioned locking elements.

According to the present disclosure, the frame 20 comprises a liner 40 made of elastomeric material, co-molded on the seat 20a, or more precisely on axially outer portions 20′, 20″ of the seat 20a.

Advantageously, the liner 40 may comprise a first portion 40′ and a second portion 40″ that are symmetrical with respect to the axis Y and co-molded respectively on the spherical surface 25′ of the annular portion 25 of the first half-frame 21 and on the spherical surface 26′ of the annular portion 26 of the second half-frame 22. In any case, the liner 40 forms a single component with the frame 20 in which it is co-molded.

Once mounting has been completed, the elastomer liner 40 is interposed between the seat 20a of the frame 20 and the spherical surface 31′ of the radially outer ring 31. Consequently, the liner 40 is interposed radially between the surfaces 25′ and 26′ of the annular portions 25 and 26 and the spherical surface 31′ of the radially outer ring 31.

Advantageously, the elastomeric material of the liner 40 may be a nitrile rubber (nitrile butadiene rubber or NBR) based on acrylonitrile and butadiene copolymers, hot or cold polymerized by emulsion polymerization. In particular, nitrile rubber or NBR has the advantage of being easy to co-mold with pressed steels, and has excellent anti-friction and general damping properties. Furthermore, NBR is of “intermediate” hardness (neither too high nor too low, for example a Shore A hardness of between 65 and 75) which enables vibrations to be damped efficiently. If the polymeric material were of high hardness, it would have a greater capacity to transmit the vibrations and would therefore be unsuitable for the purposes of the present disclosure.

Preferably, the radial thickness of the liner 40 (i.e. the radial thickness of the first portion 40′ and of the second portion 40″) is very limited, being between 0.45 mm and 0.55 mm. This is because the main objective is to reduce high-frequency vibrations, and a thin layer of liner is sufficient for this purpose.

Furthermore, the present solution in which the liner 40 is co-molded on the frame 20 and made of NBR enables the thickness of the liner 40 itself to be minimized. This is because the liner 40 is co-molded and therefore well attached to the frustoconical portions 25, 26 of the respective half-frames 21, 22, as well as being made of break-resistant material with good elastic performance to obviate the risk of being damaged during assembly.

Another advantage of the liner 40 being of lesser radial thickness is that the choice of the mounting seat 20a in the frame 20 is not affected, and seats of greater diameter or a frame larger than the frame provided for in international standards (ISO, JIS, etc.) are not required.

In summary, the present disclosure has a series of advantages, as follows:
the presence of the elastomer liner co-molded on the frame of the support assembly reduces the noise and vibration levels, in particular when the ventilation systems (or other machinery) are running at high speeds,
moreover, the bearing units are better aligned with the frame of the ventilation system. This helps to reduce the forces acting on the individual bearing units and the consequent noise and vibration levels,
the design of the elastomer liner of reduced radial thickness co-molded on the mounting seat of the frame further reduces the radial dimensions of the bearing unit,
compared to known solutions (elastomer ring interposed between the outer ring of the bearing unit and the mounting seat of the bearing unit itself in the frame), the design of this solution lastly comprises two components instead of three: the lined frame and the bearing unit.

Numerous other variants exist in addition to the embodiments of the present disclosure described above. Said embodiments are provided solely by way of example and do not limit the scope of the present disclosure, its applications or its possible configurations. Indeed, although the description provided above enables the person skilled in the art to carry out the present disclosure at least according to one example configuration thereof, numerous variations of the components described could be used without thereby departing from the scope of the present disclosure, as defined in the attached claims interpreted literally and/or according to their legal equivalents.

What is claimed is:

1. A support assembly for a rotatable element, the support assembly comprising:
a frame provided with a mounting seat and a bearing unit, disposed within the mounting seat, the bearing unit including a radially outer ring, stationary, radially outwardly delimited by a respective spherical surface, the frame including a liner of elastomeric material, co-molded on the seat, the liner being radially interposed between the seat of the frame and the spherical surface of the radially outer ring.

2. The support assembly according to claim 1, wherein the elastomeric material of the liner is a nitrile rubber.

3. The support assembly according to claim 1, wherein a radial thickness of the liner is between 0.45 mm and 0.55 mm.

4. The support assembly according to claim 1, wherein the frame is made of pressed steel.

5. The support assembly according to claim 4, wherein the frame comprises a first half-frame and a second half-frame, the two half-frames being symmetrical respect to an axis transverse to the bearing unit.

6. The support assembly according to claim 5, wherein the first half-frame comprises a flange portion and an annular portion, connected to the flange portion and radially internal with respect to the flange portion.

7. The support assembly according to claim 5, wherein the second half-frame comprises a flange portion and an annular portion, connected to the flange portion and radially internal with respect to the flange portion.

8. The support assembly according to claim 6, wherein the second half-frame comprises a flange portion and an annular portion, connected to the flange portion and radially internal with respect to the flange portion, and wherein the two flange portions are axially brought together and made integral by means of locking elements.

9. The support assembly according to claim 6, wherein the second half-frame comprises a flange portion and an annular portion, connected to the flange portion and radially internal with respect to the flange portion, and wherein the two annular portions have corresponding spherical surfaces, radially internal, which together form the mounting seat of the bearing unit inside the frame.

10. The support assembly according to claim 9, wherein the liner comprises a first portion and a second portion, symmetrical with respect to the axis, and co-molded respectively on the spherical surface of the annular portion of the first half-frame and on the spherical surface of the annular portion of the second half-frame.

11. The support assembly according to claim 2, wherein a radial thickness of the liner is between 0.45 mm and 0.55 mm.

12. The support assembly according to claim 11, wherein the frame is made of pressed steel.

13. The support assembly according to claim 12, wherein the frame comprises a first half-frame and a second half-frame, the two half-frames being symmetrical respect to an axis transverse to the bearing unit.

14. The support assembly according to claim 13, wherein the first half-frame comprises a flange portion and an annular portion, connected to the flange portion and radially internal with respect to the flange portion.

15. The support assembly according to claim 14, wherein the second half-frame comprises a flange portion and an annular portion, connected to the flange portion and radially internal with respect to the flange portion.

16. The support assembly according to claim 15, wherein the two flange portions are axially brought together and made integral by means of locking elements.

17. The support assembly according to claim 16, wherein the two annular portions have corresponding spherical surfaces, radially internal, which together form the mounting seat of the bearing unit inside the frame.

18. The support assembly according to claim 17 wherein the liner comprises a first portion and a second portion, symmetrical with respect to the axis, and co-molded respectively on the spherical surface of the annular portion of the first half-frame and on the spherical surface of the annular portion of the second half-frame.
